(19) United States
(12) Patent Application Publication
(10) Pub. No.: US 2025/0084000 A1
(43) Pub. Date: Mar. 13, 2025

(54) DEVICE AND METHOD FOR MANUFACTURING CEMENT CLINKER AND CALCINED CLAY

(71) Applicant: HSustainability GmbH, Heidelberg (DE)

(72) Inventors: Bernhard REINDL, Heidelberg (DE); Bernhard KLEINSORGE, Heidelberg (DE); Mauro CLEMENZI, Heidelberg (DE)

(73) Assignee: HSustainability GmbH, Heidelberg (DE)

(21) Appl. No.: 18/718,104

(22) PCT Filed: Dec. 8, 2022
(86) PCT No.: PCT/EP2022/085001

§ 371 Date: Jun. 10, 2024

(30) Foreign Application Priority Data
Dec. 23, 2021 (EP) 21217500.4

(51) Int. Cl. C04B 7/44; C04B 7/43; C04B 7/47; F27B 7/38; F27D 13/00; F27D 17/00

(52) U.S. Cl. CPC C04B 7/4415; C04B 7/432; C04B 7/475; F27B 7/383; F27D 13/00; F27D 17/10; F27M 2003/03

(57) ABSTRACT

A method and device for the combined manufacturing of cement clinker and calcined clay, in a cement manufacturing line by the steps: providing, preheating and precalcining a cement raw meal in a preheater and calciner section, sintering the precalcined cement raw meal in a rotary kiln and cooling the resulting cement clinker with a counter current air stream in a clinker cooler, and in a clay manufacturing line by the steps: providing and preheating a clay raw material in a heat exchange section, and calcining the preheated clay raw material suspended in gas in a flash calciner. Hot air from the cooler is divided into a first combustion air stream for sintering the cement raw meal and a second combustion air stream for calcining the clay raw material. Exhaust gas from calcining clay raw material is fed into the calcination of the preheated cement raw meal.

The present invention relates to a device and method for the simultaneous manufacturing of calcined clay and cement clinker in separate production lines with heat transfer between the production lines.

Cement is a versatile material which is widely used in building. However, manufacturing ordinary portland cement, the most common cement, is an energy intensive process believed to be responsible for a considerable amount of man-made carbon dioxide emissions. Great effort has been made to reduce the carbon footprint and also to minimize the use of natural resources. Successful proposals are especially using waste as fuel, optimization of the manufacturing conditions, use of waste as replacement raw materials, substituting clinker with pozzolanic and/or latent hydraulic materials—in particular such derived from waste—, optimization of binder composition and also recycling demolished concrete. Further, alternative cements are diligently examined. All these approaches provide progress, but many find limits due to a decreasing availability of suitable waste and the required fulfilment of safety and standardization needs.

One interesting supplementary cementitious material (abbreviated SCM herein) for substituting cement clinker is calcined clay. Interest in calcined clay has greatly increased over the last years due to a heavily rising demand for SCM and a decreasing availability of slag and fly ash, the most common SCMs. However, clay calcination in itself is an energy intensive process. Usual devices for calcining clay are rotary kilns and flash calciners. Information can be found e.g. in “A focus on flash calcining”, Int. Cement Review January 2021 and “Clay calcining technologies: the rotary kiln approach”, Int. Cement Review August 2021. An early proposal to use flash calcination is found in U.S. Pat. No. 6,168,424 B1. Furthermore, DE 10 2016 005 285 B3 describes an improved method for calcining clay using a cyclone for preheating and a co-current reactor for calcination. The air for calcination in the co-current reactor can either be ambient air or recuperation air from a cement plant.

One recent proposal to improve energy utilization during clay calcination is described in WO 2021/124261 A1. Therein, clay and cement manufacturing are combined to make heat arising in one step useful for the other. It is pointed out that calcining the clay in a rotary kiln using heat from the clinker cooler allows to reduce investment and operation costs compared to using a flash calciner. This is mainly attributable to the usually lower investment costs, especially when a closed down kiln can be used, and larger flexibility for particle size and moisture content of the clay raw material. On the other hand, as described by the documents mentioned before, flash calcination allows tighter control of calcination conditions which can be essential for providing calcined clay with appropriate pozzolanic activity. Consequently, it is not clear which device and process is best for calcining clay.

Also, there is always the object to save more energy and natural resources.

Surprisingly, it was now found that a device and method for the combined manufacturing of cement clinker and calcined clay using hot air from cement clinker cooling for clay calcination in a flash calciner and recirculation of the flash calciner exhaust gas into the cement clinker raw meal preheating and/or calcination is able to substantially reduce the overall energy demand while allowing to set optimal clay calcination conditions.

The above object is thus achieved by a method for the combined manufacturing of cement clinker and calcined clay,
wherein the cement clinker is produced by the steps:
providing a cement raw meal, preheating the cement raw meal to provide preheated cement raw meal,
precalcination of the preheated cement raw meal to provide precalcined cement raw meal,
sintering the precalcined cement raw meal in a rotary kiln to provide the cement clinker, and
cooling the cement clinker with a counter current gas stream providing hot air, and wherein the calcined clay is produced by the steps:
providing a clay raw material, if necessary ground and/or dried,
preheating the clay raw material to provide a preheated clay raw material, and
calcining the preheated clay raw material suspended in hot air to provide the calcined clay,
wherein the hot air from cooling the cement clinker is divided into at least two streams, a first combustion air stream used in sintering the precalcined cement raw meal and a second combustion air stream used in calcining the preheated clay raw material, and wherein exhaust gas from calcining the preheated clay raw material is fed into the calcination of the preheated cement raw meal. The object is further achieved by a device for the combined manufacturing of cement clinker and calcined clay, comprising a cement clinker manufacturing line and a clay calcination line, wherein the cement clinker manufacturing line comprises a cement raw meal preheater and calciner section equipped with two or more cyclones for preheating cement raw meal and a calciner comprising a calciner burner or a burning chamber supplying heated gas to the calciner section for precalcining the preheated cement raw meal, a rotary kiln for sintering the precalcined cement raw meal to cement clinker equipped with a kiln burner, and a cement clinker cooler equipped with an air supply and means for dividing hot air having passed the clinker cooler into at least two streams, and wherein the clay calcination line comprises a heat exchange section equipped with at least two cyclones for preheating a clay raw material, a fan for overcoming the additional pressure drop of the heat exchanger and a section for separating the calcined clay from air, and a clay calcination section adapted for calcining the clay raw material suspended in hot gas, preferably air, and equipped with a clay calcination burner,
wherein a part of the hot air from the clinker cooler is fed to the clay calcination section as a second combustion air; and an exhaust gas from the clay calcination section is fed back into the cement raw meal calcination where it is used as a first combustion air in the calciner burner or burning chamber.

The components used in the device according to the invention are known as such. Also, one of ordinary skill in the art is acquainted with suitable conditions to carry out the steps of the method according to the invention. The novel combination of the two processes and production lines has several advantages.

The device and method according to the invention significantly reduce the overall energy demand for manufacturing cement clinker and calcined clay by using hot off gas from cement clinker cooling as combustion air in clay calcination. Clay calcination benefits from the possibility to precisely adjust the calcination temperature by using a flash calcination. The heat exchange between clay raw material and exhaust gas from the clay calcination section allows using a simple suction fan to feed the gas to the cement clinker raw meal calcination. Only very minor changes are needed to adapt an existing cement clinker manufacturing line by integration of the clay calcination and thereby transform the plant into a device according to the invention.

Another big advantage is that the invention avoids very expensive emission control systems for SOₓ and other emissions generated in the clay calcination process.

SOₓ, i.e. SO₂ and/or SO₃, generated both from sulphite present in the clay and sulphur present in the fuels is not scrubbed in the clay calcination process as no basic material like free lime is present. In case of a stand alone clay calcination unit this would potentially lead to very high SOₓ emissions requiring an expensive scrubbing system for emission control. By rerouting gas from calcination units back to cement clinker kiln calciner, the flue gas will be “cleaned” by the free lime and limestone present in the clinker calcination process, thus reducing potential SOₓ emission to a very minimum value.

Further, organic emissions can be generated in the calcination unit from the organic material possibly present in the raw clay. By routing gas from the clay calcination line back to the clinker calcination line, organic emission will be partially or totally destroyed in the high temperature long residence time of the clinker calciner.

For other emissions like heavy metals and NOₓ the existing emission control systems are used. For example, injecting activated carbon after clinker calcination for reducing mercury and/or reducing NOₓ in the SNCR-system (or SCR-System) of the clinker calcination process. So, the method and device according to the invention have the big advantage, that no additional emission control systems for SOₓ, NOₓ, organic emissions, or heavy metals like Hg have to be installed.

The method and device according to the invention will be explained in more detail in the following including preferred embodiments thereof. Further advantages will also become apparent therefrom.

The cement manufacturing steps and lines correspond to the usual steps and devices used in manufacturing of any kind of portland cement clinker, calcium-sulfo-aluminate clinker and calcium-sulfo-aluminate-belite clinker. In fact, it is one advantage of the present invention that an existing cement manufacturing line can easily be retrofitted with the clay calcination line to convert it into a device according to the invention.

As usual, cement raw meal is provided in a first step for the cement manufacturing. Typically, cement raw materials are ground and mixed as well as dried when necessary to obtain the cement raw meal. Mix design and particle sizes are adjusted as usual. Exhaust gas from the cement clinker production process (kiln) is usually used for drying cement raw materials within the grinding process.

The cement raw meal is then preheated in counter current flow with exhaust gas from the cement clinker kiln. A useful preheating section comprises at least two, often three or four, cyclones. According to the invention the preheating is coupled with a calcination to decarbonate a substantial amount of the calcium carbonate in the preheated cement clinker raw meal. Typically, decarbonation is not complete, a minor amount of the carbonate is only decarbonated in the kiln. The calciner receives preheated raw meal and gas which is heated by a calciner burner and/or in a separate burning chamber connected to the calciner. The burning process in the calciner can take place with conventional fossil fuels like gas, petroleum, and coal, but preferably it works with alternative fuels to reduce the carbon footprint of the whole process. Suitable alternative fuels are for example but not limited to combustible municipal, industrial and commercial waste, refuse-derived fuels, and biomass. At least a part of the combustion air for the calciner burner or burning chamber is provided by the exhaust gas from the clay calcination. Within the burning chamber or through the calciner burner the exhaust gas is heated to a temperature needed for the cement clinker raw meal calcination. Additionally, all heat needed for the cement clinker raw meal calcination is added to the calciner burner or burning chamber using fuels as mentioned before. The gas heated in the calciner burner or burning chamber is generated in or fed into the cement calciner to start the calcination process. An advantage of using a burning chamber is that ashes coming from the burning process can be directed to the clinker sintering process in the kiln. Thus, a burning chamber is especially suitable for solid fuels generating a substantial amount of ashes. The preheated and subsequently precalcined cement clinker raw meal typically comprises from a few percent, e.g. from 1 to 5 wt.-%, up to 30 or 40 wt.-% carbonate with respect to the total weight of the raw meal.

The precalcined cement raw meal is fed to the rotary kiln as usual. Inside the rotary kiln it is sintered to provide cement clinker. The kiln burner can also work either with fossil fuels or with alternative fuels. Again at least partly using alternative fuels is preferred. The combustion air for the kiln burner comes from the cement clinker cooler as known per se.

The obtained cement clinker passes from the kiln to the cooler where it is cooled down with a counter current air stream. All known cooler types are useful, preferred are grate coolers. According to the invention, a part of the air heated up during cement clinker cooling is used as a first combustion air for sintering cement clinker raw meal in the rotary kiln as usual. Another part (tertiary air) may be guided directly into the cement clinker raw meal calciner or used otherwise, e.g. for drying cement clinker raw materials, also as usual. In contrast to the usual procedure, a part of the hot air from the cement clinker cooler is divided out and used as a combustion air in the clay calcination.

The cooled cement clinker is processed as usual, e.g. ground to cement with or without further constituents like sulfate. In one preferred embodiment the cement, i.e. the ground cement clinker, is mixed with the calcined clay to provide a composite cement.

For the clay calcination line, clay raw material is provided first. Clay raw material can have very variable compositions. Preferred clay raw materials contain substantial amounts of clay minerals like kaolinite, illite and montmorillonite, most preferred kaolinite. Typically, at least 15 wt.-%, preferably at least 20 wt.-%, most preferred at least 30 wt.-% clay minerals should be contained.

The clay raw material can be pre-processed if necessary. For example, but not limited to, it can be dried to less than 1 wt.-% residual moisture and/or ground to a fineness around 10 to 15 wt.-% residue on a 90 μm sieve. For example hot kiln off gas in combination with any grinding equipment feasible is useful for this.

In a preferred embodiment, non-clay phases like quartz and feldspar are separated off, e.g. as described in EP 4 001 236 A1. Thereby, wear on the clay calcination section is reduced and unnecessary energy consumption for heating material not participating in the calcination is avoided.

The clay raw material is preheated in a heat exchange section of the clay calcination line. A cyclone preheater with at least two, typically three or four cyclones, is used for this. The clay raw material is fed to the gaseous stream fed into the uppermost cyclone. The gaseous stream comprising calcined clay and exhaust gas from the clay calcination is fed to the lowermost cyclone. From that, calcined clay is obtained as solid material stream and guided into a cooling section, e.g. a heat exchanger, preferably a cyclone heat exchanger. The heat exchange section cools the exhaust gas from the clay calcination section transferring heat to the clay raw material for preheating it. Typically, the heat exchange cools the exhaust gas to a temperature, normally <450° C., allowing the use of a fan, preferably a booster fan, to feed the cooled exhaust gas to the cement raw meal calcination. Using a booster fan greatly eases retrofitting of existing cement manufacturing lines with the clay calcination line. In one embodiment the clay calcination line comprises a gas conditioning tower to provide additional cooling of the exhaust gas after it has been heat exchanged with the clay raw material. Preferably, the gas is cooled with injected water inside the gas conditioning tower. Thereby, it is still possible to use a cost effective fan to counteract the pressure drop of the second combustion air in the clay calcination line when high amounts of hot air are fed to the clay calcination line to save fuel for flash calcination.

Calcination of the clay raw material takes place with the clay raw material particles suspended in the gas heated by the clay calcination burner, preferably in a flash calciner. The calcination temperature (adjusted via the burner) and the residence time (adjusted by volume flow rate of the gas in the device) are adjusted to ensure essentially complete dehydroxylation of the clay phases while avoiding crystallization. In the case of clay phase mixtures where that is not possible a suitable compromise is defined to obtain the highest possible pozzolanic activity of the calcined clay. Typically, temperatures in the range from 600 to 980° C. and residence times from a few seconds, e.g. 1, 2 or 3 seconds, up to 5 or 10 seconds, are useful. The optimum temperature for a given clay raw material can be deter-mined by thermogravimetry and differential scanning calorimetry. Often 750 to 850° C. is optimum but lower limits of 650 or 700° C. or upper limits of 900 or 950° C. or even above 980° C. are possible. The clay calcination burner can work with fossil fuels and alternative fuels. Preferably, it works with alternative fuels. Since the combustion air is provided by the hot air from the cement clinker cooler, energy demand is substantially reduced as compared to a use of ambient air or of a gas derived from “only” cooling the calcined clay as the second combustion air stream.

The calcined clay, which is separated from the exhaust gas in the heat exchanger section and cooled in a section for cooling calcined clay, is usually ready for mixing with cement. Calcination in gas suspension safely avoids agglomeration of the particles. Mixing of the calcined clay with the cement provides the composite cement. It can be accomplished in any known device, e.g. but not limited to in a mixing silo, drum, cooler, blender. The calcined clay can also be stored, e.g. in a silo, before mixing. Further, it is possible to add additional cement components during mixing cement and calcined clay, e.g. other constituents, admixtures, and/or additives. The most common other constituents are described in EN 197-1, for example limestone, fly ashes and ground granulated blast furnace slag. Other SCM can also be used like bottom ash and slags from other sources than pigiron making. Typical admixtures are water reducers, plasticizers, super plasticizers, retarders, set retarders and accelerators or strength enhancers. Composite cements made from calcined clay obtained by the method according to the invention have a significantly reduced carbon footprint.

The invention will be illustrated further with reference to the attached figures, without restricting the scope to the specific embodiments described. The invention includes all combinations of described and especially of preferred features that do not exclude each other.

If not otherwise specified any amount in % or parts is by weight and in the case of doubt referring to the total weight of the composition/mixture concerned. A characterization as “approximately”, “around” and similar expression in relation to a numerical value means that up to 10% higher and lower values are included, preferably up to 5% higher and lower values, and in any case at least up to 1% higher and lower values, the exact value being the most preferred value or limit. The term “substantially free” means that a particular material is not purposefully added to a composition, and is only present in trace amounts or as an impurity. As used herein, unless indicated otherwise, the term “free from” means that a composition does not comprise a particular material, i.e. the composition comprises 0 weight percent of such material.

In the figures,

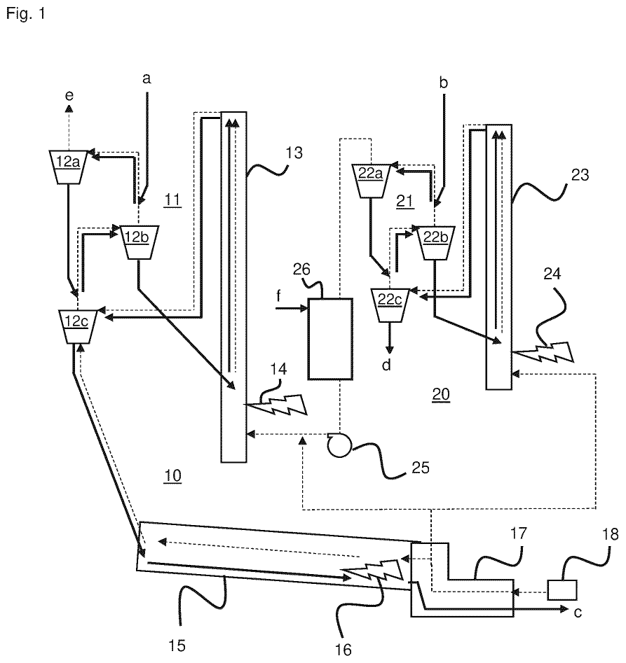

FIG. 1 shows a first embodiment of a device according to the invention,

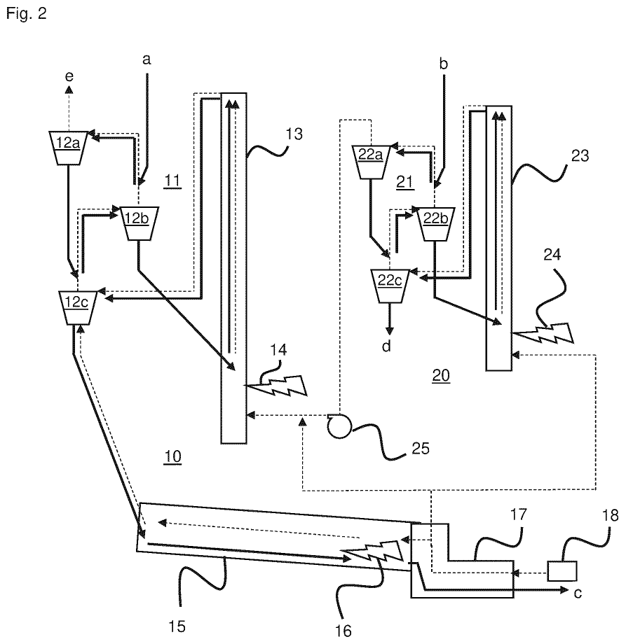

FIG. 2 shows a second embodiment, and

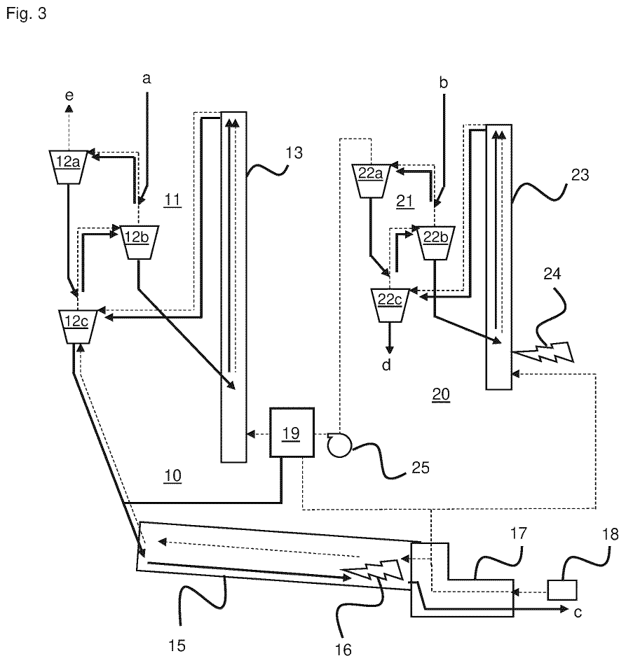

FIG. 3 shows a third embodiment.

FIG. 1 schematically shows a device according to the invention comprising a cement clinker manufacturing line 10 and a clay calcination line 20. The cement clinker manufacturing line 10 comprises a cement raw meal preheater and calciner section 11 equipped with three cyclones 12a, 12b, 12c for preheating cement raw meal a and a calciner 13 comprising a calciner burner 14 for precalcining the preheated cement raw meal. The cement clinker manufacturing line 10 further comprises a rotary kiln 15 equipped with a kiln burner 16 for sintering the precalcined cement raw meal to cement clinker c. The cement clinker manufacturing line 10 also comprises a cement clinker cooler 17 equipped with an air supply 18 and means for dividing hot air having passed the clinker cooler 17 into at least two streams. The clay calcination line 20 comprises a heat exchange section 21 equipped with three cyclones 22a, 22b, 22c for simultaneously preheating the clay raw material b and separating the calcined clay d from the air. The clay calcination line 20 further comprises a clay calcination section 23 adapted for calcining the preheated clay raw material being suspended in gas. The clay calcination section 23 is equipped with a clay calcination burner 24. A fan 25 is provided to transfer exhaust gas from the clay calcination section 23 to the calciner 13. A gas conditioning tower 26 equipped with a supply for water f is foreseen for cooling of the exhaust gas transferred from heat exchange section 21 to the calcination 13. Gas and air streams are indicated with dotted lines and material streams with solid lines in FIG. 1.

For operation cement clinker raw meal a is fed to the gaseous stream rising from cyclone 12b to cyclone 12a. Clay raw material b is fed to the gaseous stream rising from cyclone 22b to cyclone 22a. Air is fed to the cooler 17 via the gas supply 18. Cooled exhaust gas e is discharged from the cement manufacturing line 10 from cyclone 12a and proceeded as normal. Remaining heat in the exhaust gas e can be used e.g. to dry raw materials but also in other ways. Finally, exhaust gas e from the cement manufacturing line 10 will be vented to the stack of the plant, usually after having been cleaned from NOₓ, SOₓ, heavy metals, and dust as needed. Such cleaning is known per se and can also occur in and in between devices shown in FIG. 1, e.g. in the gas conditioning tower 26. Cooled cement clinker c leaves the cooler 17 and is also processed further as known. Calcined clay d is cooled after leaving the heat exchange section 21 and having been taken out from the cyclone 22c. The exhaust gas from the clay calcination 23 is utilized to preheat the clay raw material b and the cooled gas is transferred to the cement precalcination 13. The burners 14, 16, and 24 are fed both with conventional and alternative fuels. The fuel feed is not shown in the figures. In the shown set-up some gas from the cement clinker cooler 17 is transferred to the cement raw meal precalcination 13.

The device schematically shown in FIG. 2 is very similar to the embodiment shown in FIG. 1, the same parts are designated with the same reference signs. The difference between FIG. 1 and FIG. 2 is that due to smaller amounts of hot air being used as second combustion air in the clay calcination section 23 a gas conditioning tower is not needed. The temperature of the exhaust gas leaving cyclone 22a is low enough to pass it into the fan 25. Of course, this set-up can also be used with higher exhaust gas temperature when the fan 25 is compatible with such higher temperatures.

In FIG. 3 a device with a burning chamber 19 instead of a calciner burner 14 is illustrated. Thus, exhaust gas from the clay calcination line 20 and tertiary air from clinker cooler 17 are fed into the burning chamber 19. Again, the fuel feed is not shown. Ashes resulting from burning fuel in the burning chamber 19 are passed into the rotary kiln 15, preferably by adding them to the precalcined raw meal as shown.

### REFERENCE NUMBERS

10 cement manufacturing line
11 preheating and calcination section
12a cyclone
12b cyclone
12c cyclone
13 calciner, cement precalcination
14 calciner burner
15 rotary kiln
16 kiln burner
17 cement clinker cooler
18 air supply
19 burning chamber
20 clay manufacturing line
21 heat exchange section
22a cyclone
22b cyclone
22c cyclone
23 clay calcination section, flash calciner
24 clay calcination burner
25 fan
26 gas conditioning tower
a cement raw meal
b clay raw material
c cement clinker
d calcined clay
e exhaust gas
f water

1: A method for the combined manufacturing of cement clinker and calcined clay, wherein
the cement clinker is produced by the steps:
providing a cement clinker raw meal, preheating the cement clinker raw meal to provide preheated cement clinker raw meal, precalcination of the preheated cement clinker raw meal to provide precalcined cement clinker raw meal, sintering the precalcined cement clinker raw meal in a rotary kiln to provide the cement clinker and cooling the cement clinker with a counter current air stream providing hot air, and the calcined clay is produced by the steps:
providing a clay raw material, preheating the clay raw material to provide preheated clay raw material, calcining the preheated clay raw material suspended in hot gas to provide the calcined clay, and cooling the calcined clay;
wherein the hot air from cooling the cement clinker is divided into at least two streams comprising a first combustion air stream used in sintering the precalcined cement raw meal and a second combustion air stream used in calcining the preheated clay raw material, and wherein exhaust gas from calcining the preheated clay raw material is fed into the calcination of the preheated cement raw meal.

2: The method according to claim 1, wherein the exhaust gas from calcining the preheated clay raw material is conditioned with water.

3: The method according to claim 1, wherein the preheated cement clinker raw meal is calcined with heat provided by a burning chamber fed with solid fuels.

4: The method according to claim 1, wherein the precalcined cement clinker raw meal comprises from 5 wt.-% up to 40 wt.-% carbonate.

5: The method according to claim 1, wherein the clay raw material is dried to less than 1 wt.-% moisture and/or ground to a fineness of less than 15 wt.-% residue on a 90 μm sieve.

6: The method according to claim 1, wherein the temperature in the clay calcination is adjusted to range from 700° C. up to 900° C.

7: The method according to claim 1, wherein the residence time in the clay calcination is adjusted to range from 3 seconds up to 10 seconds.

8: A device for the combined manufacturing of cement clinker and calcined clay, comprising a cement clinker manufacturing line and a clay calcination line,
wherein the cement clinker manufacturing line comprises a cement clinker raw meal preheater and calciner section equipped with two or more cyclones for preheating the cement clinker raw meal and a calciner comprising a calciner burner or a burning chamber for precalcining the preheated cement clinker raw meal, a rotary kiln equipped with a kiln burner for sintering the precalcined cement clinker raw meal to cement clinker, and a cement clinker cooler equipped with an air supply for cooling the cement clinker and means for dividing hot air having passed the clinker cooler into at least two streams,
wherein the clay calcination line comprises a heat exchange section equipped with at least two cyclones for preheating a clay raw material, a section for cooling the calcined clay, and a clay calcination section adapted for calcining preheated clay raw material suspended in gas and equipped with a clay calcination burner, and
wherein a part of the hot air from the cement clinker cooler is fed to the rotary kiln as a first combustion air and another part is fed to the clay calcination section as a second combustion air; and an exhaust gas from the clay calcination section is fed into the calciner.

9: The device according to claim 8, wherein the section for cooling the calcined clay is a heat exchanger.

10: The device according to claim 8 comprising a gas conditioning tower for conditioning the exhaust gas from calcining the preheated clay raw material.

11: The device according to claim 8 comprising a fan for transferring the exhaust gas from calcining the preheated clay raw material to the calcination of the preheated cement raw meal.

12: The device according to claim 8, wherein the clay calcination section is a flash calciner.

13: The method according to claim 1, wherein the clay is calcined in a flash calciner.

14: The method according to claim 13, wherein the temperature in the clay calcination is adjusted to range from 700° C. up to 900° C.

15: The method according to claim 14, wherein the residence time in the clay calcination is adjusted to range from 3 seconds up to 10 seconds.

16: The method according to claim 13, wherein the exhaust gas from calcining the preheated clay raw material is conditioned with water.

17: The device according to claim 9, wherein the section for cooling the calcined clay is a cyclone heat exchanger.

18: The device according to claim 12, wherein the section for cooling the calcined clay is a cyclone heat exchanger.

19: The device according to claim 18 comprising a gas conditioning tower for conditioning the exhaust gas from calcining the preheated clay raw material.

20: The device according to claim 19 comprising a booster fan for transferring the exhaust gas from calcining the preheated clay raw material to the calcination of the preheated cement raw meal.
